(19) United States
(12) Patent Application Publication
(10) Pub. No.: US 2013/0057196 A1
(43) Pub. Date: Mar. 7, 2013

(54) PHOTOVOLTAIC POWERED SYSTEM WITH ADAPTIVE POWER CONTROL AND METHOD OF OPERATING THE SAME

(71) Applicants: Chen-Wei KU, Taoyuan County (TW); Lei-Ming LEE, Taoyuan County (TW); Ho HUANG, Taoyuan County (TW)

(72) Inventors: Chen-Wei KU, Taoyuan County (TW); Lei-Ming LEE, Taoyuan County (TW); Ho HUANG, Taoyuan County (TW)

(21) Appl. No.: 13/371,963

(22) Filed: Feb. 13, 2012

(30) Foreign Application Priority Data
Sep. 5, 2011 (TW) 100131918

(51) Int. Cl. H01M 10/46

(52) U.S. Cl. 320/101

(57) ABSTRACT

A photovoltaic powered system with an adaptive power control and a method of operating the same. A photovoltaic panel is provided to generate electric power to supply a load. The photovoltaic powered system includes a charging control unit, a rechargeable battery unit, a first switch unit, a second switch unit, a power condition unit, and a switch control unit. The switch control unit turns on the first switch unit and turns off the second switch unit when the photovoltaic panel can generate the electric power, thus supplying the load and charging the rechargeable battery unit, respectively. The switch control unit turns off the first switch unit and turns on the second switch unit when the photovoltaic panel cannot generate the electric power, thus providing energy stored in the rechargeable battery unit to supply the load.

### BACKGROUND OF THE INVENTION

1. Field of the Invention

The present invention relates generally to a photovoltaic powered system and a method of operating the same, and more particularly to a photovoltaic powered system with an adaptive power control and a method of operating the same.

2. Description of Prior Art

After the second energy crisis occurred in 1970s, many countries make efforts in seeking and researching alternative sources. Basically, the alternative sources include wind energy, solar energy, geothermal energy, tidal energy, ocean current energy, but without involving coal, petroleum, natural gas, and nuclear energy. Because the solar energy has the pollution-free and public harm-free characteristics and is further inexhaustible in supply and always available for use, the solar energy has high potential applications and developments. Recently with the rapidly development of the high-efficiency solar cells, this topic has been gradually promoted by making policies in many developed countries, such as Europe countries, the United States, Japan, and so on.

The solar photovoltaic system provides a photovoltaic conversion to generate a DC power through the solar cell panels. Afterward, the DC power is converted into an AC power through a power conditioner to supply to a load or the converted AC power is grid-connected to an AC utility power through the utility grid bus. The solar photovoltaic system can be broadly divided into three categories: (1) stand-alone system, (2) grid-connection system, and (3) hybrid system.

The stand-alone system means that the solar photovoltaic system is completely operational without requiring external support and only directly supply to a load. Hence, the stand-alone system is generally built in remote areas or isolated islands. In particular, the required power electricity of a load is either the wind power or the solar power. The solar power or/and the wind power can further provide redundant power to charge the standby battery, whereas the load can be supplied through the battery when the solar power or/and the wind power is insufficient. The grid-connection system means that the solar photovoltaic system is further connected to the power grid of the electric power company. Hence, the grid-connection system is suitable for where the utility power can reach. When the amount of electricity generation of the solar photovoltaic system is greater than that of load demands, the redundant power remains would be delivered to the utility grid bus. On the other hand, the utility power can provide the required power electricity to a load when the amount of electricity generation of the solar photovoltaic system is insufficient. Furthermore, in order to improve the power supply reliability and quality, the hybrid system is developed. The solar photovoltaic system, which is combined with standby batteries, is immediately separated from the utility power to temporarily provide power electricity to a load when the utility power fails. The solar photovoltaic system is further grid-connected to the utility grid bus until the utility power is available.

Reference is made to FIG. 1 which is a block diagram of a prior art photovoltaic powered system. The photovoltaic powered system generates a DC voltage (not labeled) and a DC current (not labeled) through a photovoltaic panel 10A. The DC voltage and the DC current are controlled to provide electric power to supply a load 50A. The photovoltaic powered system includes a charging control unit 20A, a switch unit Sw, a rechargeable battery unit 30A, and a power condition unit 40A.

The charging control unit 20A is electrically connected to the photovoltaic panel 10A. The switch unit Sw is electrically connected to the charging control unit 20A. The rechargeable battery unit 30A is electrically connected to the photovoltaic panel 10A and the switch unit Sw. The power condition unit 40A is electrically connected to the switch unit Sw and the rechargeable battery unit 30A. In particular, the charging control unit 20A turns on/off the switch unit Sw according to the electric power generated from the photovoltaic panel 10A.

The charging control unit 20A turns on the switch unit Sw when the photovoltaic panel 10A can provide the electric power when the photovoltaic panel 10A can provide the electric power. Also, the power condition unit 40A regulates the electric power generated from the photovoltaic panel 10A to supply the load 50A and to charge the rechargeable battery unit 30A. On the other hand, the power condition unit 40A regulates the electric power outputted from the rechargeable battery unit 30A to supply the load 50A when the photovoltaic panel 10A cannot provide the electric power.

When the photovoltaic panel 10A can provide the electric power, the power condition unit 40A is provided to regulate the electric power for supplying the load 50A and charging the rechargeable battery unit 30A. That is, the charging control unit 20A is used when both the load 50A is supplied and the rechargeable battery unit 30A is charged by the photovoltaic panel 10A. Accordingly, a power-supplying loop of supplying the electric power to the load 50A and a charging loop of charging the rechargeable battery unit 30A are both through the charging control unit 20A.

Because of conduction losses and switching losses of switches of the charging control unit 20A, the losses reduce conversion efficiency of the charging control unit 20A due to energy consumption during the energy conversion operation. Also, the charging control unit 20A is always used when the electric power generated from the photovoltaic panel 10A is provided to supply the load 50A or to charge the rechargeable battery unit 30A, thus significantly reducing the whole efficiency of the photovoltaic powered system.

Accordingly, it is desirable to provide a photovoltaic powered system with an adaptive power control and a method of operating the same. A photovoltaic panel is provided to generate the electric power to supply the load and to charge the rechargeable battery unit under different daytime/evening or climatic conditions, thus increasing the whole efficiency of the photovoltaic powered system by controlling different switch units turning on and turning off.

### SUMMARY OF THE INVENTION

An object of the invention is to provide a photovoltaic powered system with an adaptive power control to solve the above-mentioned problems.

The photovoltaic powered system with an adaptive power control generates a DC voltage and a DC current through a photovoltaic panel. The DC voltage and the DC current are controlled to provide electric power to supply a load. The photovoltaic powered system includes a charging control unit, a rechargeable battery unit, a first switch unit, a second switch unit, a power condition unit, and a switch control unit.

The charging control unit is electrically connected to the photovoltaic panel. The rechargeable battery unit is electrically connected to the photovoltaic panel and the charging control unit. The first switch unit is electrically connected to the photovoltaic panel. The second switch unit is electrically connected to the charging control unit and the rechargeable battery unit. The power condition unit is electrically connected to the photovoltaic panel, the first switch unit, and the second switch unit. The switch control unit is electrically connected to the photovoltaic panel, the first switch unit, and the second switch unit. The switch control unit receives the DC voltage and the DC current generated from the photovoltaic panel to turn on/off the first switch unit and the second switch unit.

The switch control unit turns on the first switch unit and turns off the second switch unit when the photovoltaic panel can provide the electric power. Hence, the electric power generated from the photovoltaic panel can be regulated to supply the load by the power condition unit and the electric power generated from the photovoltaic panel can be controlled to charge the rechargeable battery unit by the charging control unit.

The switch control unit turns off the first switch unit and turns on the second switch unit when the photovoltaic panel cannot provide the electric power. Hence, the electric power stored in the rechargeable battery unit can be regulated to supply the load by the power condition unit.

Another object of the invention is to provide a method of operating a photovoltaic powered system with an adaptive power control to solve the above-mentioned problems.

The method of operating the photovoltaic powered system with an adaptive power control provides a photovoltaic panel to generate a DC voltage and a DC current. The DC voltage and the DC current are controlled to provide the electric power to supply a load. Steps of operating the photovoltaic powered system with an adaptive power control includes: (a) a charging control unit and a rechargeable battery unit are provided; (b) a first switch unit and a second switch unit are provided; (c) a power condition unit is provided; and (d) a switch control unit is provided. Wherein the switch control unit receives the DC voltage and the DC current generated from the photovoltaic panel to turn on/off the first switch unit and the second switch unit.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a prior art photovoltaic powered system;

FIG. 2 is a block diagram of a photovoltaic powered system with an adaptive power control according to the present invention;

FIG. 3 is a schematic block diagram of providing an electric power control of the photovoltaic powered system according to the present invention;

FIG. 4 is a schematic block diagram of providing another electric power control of the photovoltaic powered system according to the present invention; and

FIG. 5 is a flowchart of a method of operating a photovoltaic powered system with an adaptive power control.

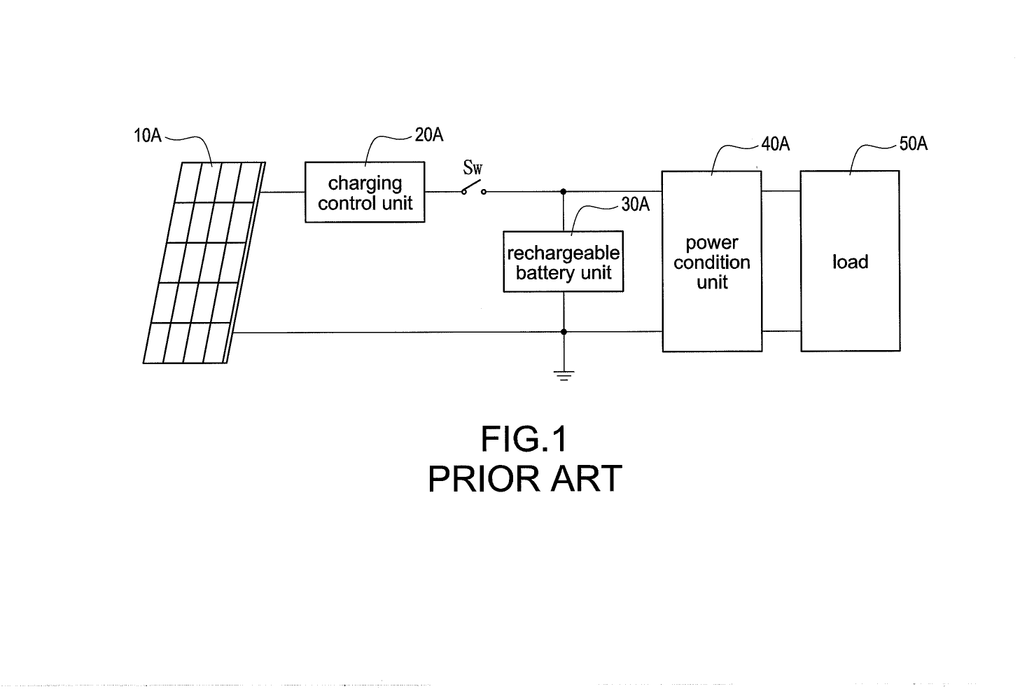

### DETAILED DESCRIPTION OF THE INVENTION

Reference will now be made to the drawing figures to describe the present invention in detail.

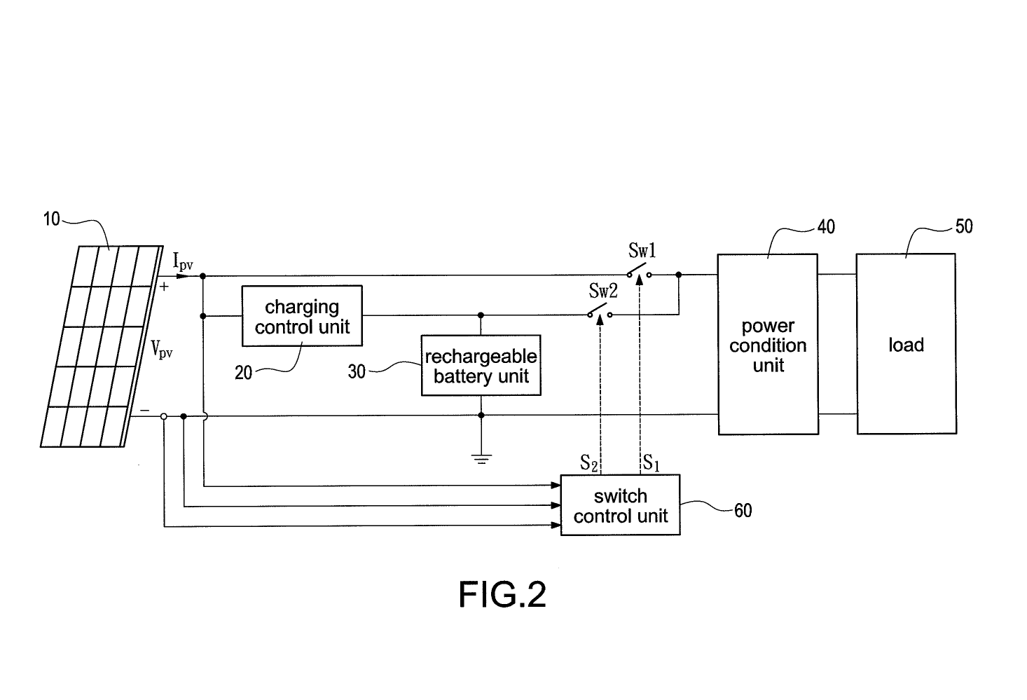

Reference is made to FIG. 2 which is a block diagram of a photovoltaic powered system with an adaptive power control according to the present invention. The photovoltaic powered system with an adaptive power control generates a DC voltage Vpv and a DC current Ipv through a photovoltaic panel 10. The DC voltage Vpv and the DC current Ipv are controlled to provide the electric power to supply a load 50. The photovoltaic powered system includes a charging control unit 20, a rechargeable battery unit 30, a first switch unit Sw1, a second switch unit Sw2, a power condition unit 40, and a switch control unit 60.

The charging control unit 20 is electrically connected to the photovoltaic panel 10. The rechargeable battery unit 30 is electrically connected to the photovoltaic panel 10 and the charging control unit 20. Note that, the charging control unit 20 controls required charging voltage and charging current of the rechargeable battery unit 30 and controls operating points of the DC voltage Vpv and the DC current Ipv generated from the photovoltaic panel 10 to provide a maximum power point tracing (MPPT) control. The first switch unit Sw1 is electrically connected to the photovoltaic panel 10. The second switch unit Sw2 is electrically connected to the charging control unit 20 and the rechargeable battery unit 30. The power condition unit 40 is electrically connected to the photovoltaic panel 10, the first switch unit Sw1, and the second switch unit Sw2. In particular, the power condition unit 40 can be a DC-to-AC inverter. In addition, the power condition unit 40 can also control operating points of the DC voltage Vpv and the DC current Ipv generated from the photovoltaic panel 10 to provide a maximum power point tracing (MPPT) control. Note that, the used topologies of the power condition unit 40 are depended on application demands, but not limited. The switch control unit 60 is electrically connected to the photovoltaic panel 10, the first switch unit Sw1, and the second switch unit Sw2. The switch control unit 60 receives the DC voltage Vpv and the DC current Ipv generated from the photovoltaic panel 10 to turn on/off the first switch unit Sw1 and the second switch unit Sw2.

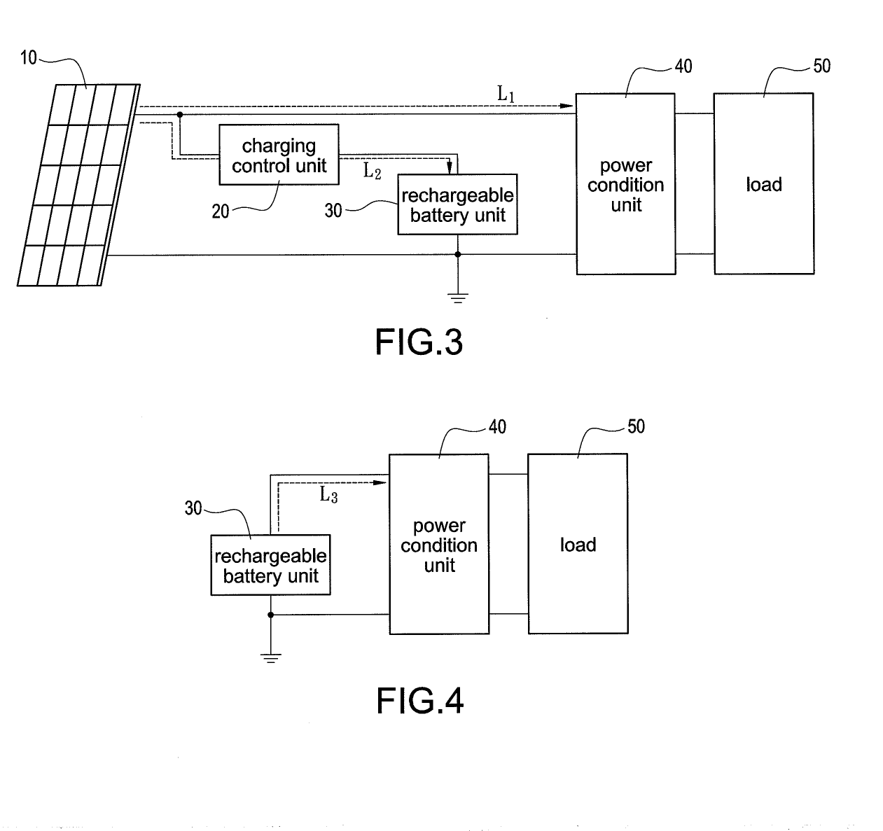

The detailed operation of the photovoltaic powered system with the adaptive power control will be described as follows. Reference is made to FIG. 3 which is a schematic block diagram of providing an electric power control of the photovoltaic powered system according to the present invention. The switch control unit 60 turns on the first switch unit Sw1 and turns off the second switch unit Sw2 when the photovoltaic panel 10 can provide the electric power. Hence, the electric power generated from the photovoltaic panel 10 can be regulated to supply the load 50 by the power condition unit 40. At this time, a first power-supplying loop L1 of providing the electric power to supply the load 50 from the photovoltaic panel 10 is shown in FIG. 3.

Simultaneously, the electric power generated from the photovoltaic panel 10 can be controlled to charge the rechargeable battery unit 30 by the charging control unit 20 so that the electric power can be stored in the rechargeable battery unit 30. At this time, a second power-supplying loop L2 of providing the electric power to charge the rechargeable battery unit 30 from the photovoltaic panel 10 is shown in FIG. 3.

Especially to deserve to be mentioned, the switch control unit 60 is electrically connected to the photovoltaic panel 10 to receive the DC voltage Vpv and the DC current Ipv generated from the photovoltaic panel 10. Also, the switch control unit 60 judges whether the photovoltaic panel 10 can provide the electric power or not according to magnitude of the DC voltage Vpv and the DC current Ipv. That is, the photovoltaic panel 10 provides an amount of the electric power that is equal to a product of the DC voltage Vpv and the DC current Ipv when neither the DC voltage Vpv nor the DC current Ipv is zero. In practical applications, the photovoltaic panel 10 usually can output the electric power when the photovoltaic powered system is operated in a daytime or in a sunny day, namely, in a fine day. That is, when the photovoltaic powered system is operated in a daytime or in a sunny day, the outputted electric power from the photovoltaic panel 10 can be regulated to supply the load 50 by the power condition unit 40. Simultaneously, the electric power generated from the photovoltaic panel 10 can be controlled to charge the rechargeable battery unit 30 by the charging control unit 20 so that the electric power can be stored in the rechargeable battery unit 30. Accordingly, the electric power generated from the photovoltaic panel 10 can be directly supplied to the load 50 and also the redundant electric power can be stored in the rechargeable battery unit 30.

When the photovoltaic panel 10 can provide the electric power, the power condition unit 40 can regulate the electric power to supply the load 50 and charge the rechargeable battery unit 30. That is, the power condition unit 40 can regulate the electric power generated from the photovoltaic panel 10 according to the required power of the load 50. In addition, the remaining electric power generated from the photovoltaic panel 10 is stored in the rechargeable battery unit 30.

In the above-mentioned operation, the switch control unit 60 produces a first control signal S1 to turn on the first switch unit Sw1 and produces a second control signal S2 to turn off the second switch unit Sw2. Note that, the first control signal S1 and the second control signal S2 are complementary-level signals, that is, the second control signal S2 is a low-level signal to turn off the second switch unit Sw2 when the first control signal S1 is a high-level signal to turn on the first switch unit Sw1.

Reference is made to FIG. 4 which is a schematic block diagram of providing another electric power control of the photovoltaic powered system according to the present invention. The switch control unit 60 turns off the first switch unit Sw1 and turns on the second switch unit Sw2 when the photovoltaic panel 10 cannot provide the electric power. Hence, the electric power stored in the rechargeable battery unit 30 can be regulated to supply the load 50 by the power condition unit 40. At this time, a third power-supplying loop L3 of providing the electric power to supply the load 50 from the rechargeable battery unit 30 is shown in FIG. 4.

Especially to deserve to be mentioned, the switch control unit 60 is electrically connected to the photovoltaic panel 10 to receive the DC voltage Vpv and the DC current Ipv generated from the photovoltaic panel 10. Also, the switch control unit 60 judges whether the photovoltaic panel 10 can provide the electric power or not according to magnitude of the DC voltage Vpv and the DC current Ipv. That is, the photovoltaic panel 10 provides an amount of the electric power that is equal to zero when both the DC voltage Vpv and the DC current Ipv are zero. In practical applications, the photovoltaic panel 10 usually cannot output the electric power when the photovoltaic powered system is operated in an evening. That is, when the photovoltaic powered system is operated in an evening, the outputted electric power from the rechargeable battery unit 30 can be regulated to supply the load 50 by the power condition unit 40. That is, the rechargeable battery unit 30 can operated to supply the stored electric power to the load 50 when the photovoltaic panel 10 cannot provide the electric power to the load 50. In addition, the power condition unit 40 regulates the stored electric power in the rechargeable battery unit 30 to supply the load 50 when the photovoltaic panel 10 cannot provide the electric power. That is, the power condition unit 40 can regulate the electric power outputted from the rechargeable battery unit 30 according to the required power of the load 50.

In the above-mentioned operation, the switch control unit 60 produces the first control signal S1 to turn off the first switch unit Sw1 and produces the second control signal S2 to turn on the second switch unit Sw2. Note that, the first control signal S1 and the second control signal S2 are complementary-level signals, that is, the second control signal S2 is a high-level signal to turn on the second switch unit Sw2 when the first control signal S1 is a low-level signal to turn off the first switch unit Sw1.

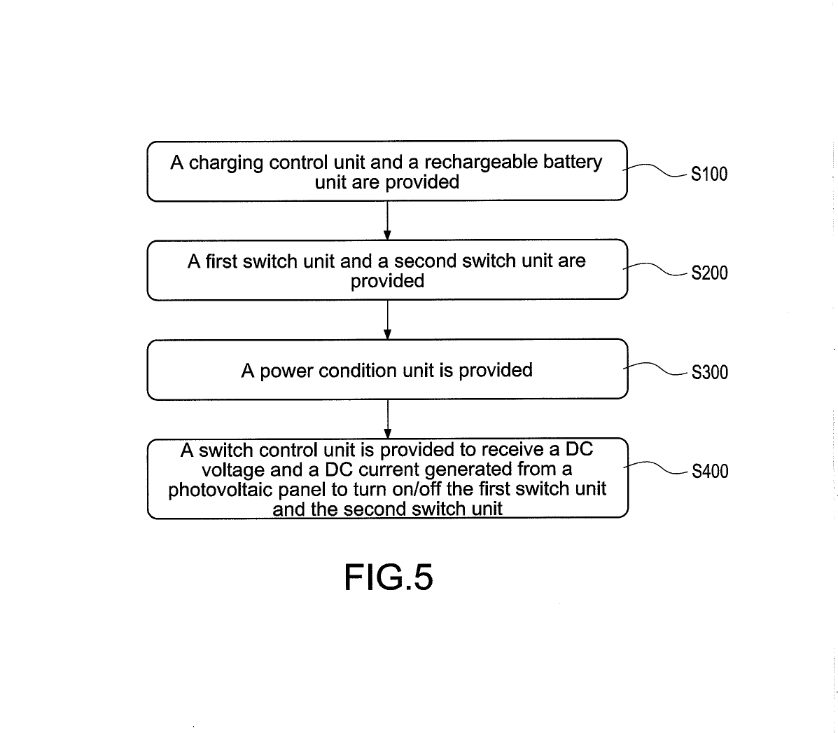

Reference is made to FIG. 5 which is a flowchart of a method of operating a photovoltaic powered system with an adaptive power control. The photovoltaic powered system with the adaptive power control provides a photovoltaic panel to generate a DC voltage and a DC current. The DC voltage and the DC current are controlled to provide an electric power to supply a load. The method of operating the photovoltaic powered system with the adaptive power control includes following steps: A charging control unit and a rechargeable battery unit are provided (S100). A first switch unit and a second switch unit are provided (S200). A power condition unit is provided (S300). In particular, the power condition unit is a DC-to-AC inverter. In addition, the power condition unit can control operating points of the DC voltage and the DC current generated from the photovoltaic panel to provide a maximum power point tracing (MPPT) control. A switch control unit is provided (S400). Wherein the switch control unit receives the DC voltage and the DC current generated from the photovoltaic panel to turn on/off the first switch unit and the second switch unit. Note that, the switch control unit produces a first control signal and a second control signal to turn on/off the first switch unit and the second switch unit, respectively. In particular, the first control signal and the second control signal are complementary-level signals. That is, the second control signal is a low-level signal to turn off the second switch unit when the first control signal is a high-level signal to turn on the first switch unit. On the other hand, the second control signal is a high-level signal to turn on the second switch unit when the first control signal is a low-level signal to turn off the first switch unit.

In the step (S400), the switch control unit turns on the first switch unit and turns off the second switch unit when the photovoltaic panel can provide the electric power so that the electric power generated from the photovoltaic panel is regulated to supply the load by the power condition unit. Simultaneously, the electric power generated from the photovoltaic panel is controlled to charge the rechargeable battery unit by the charging control unit so that the electric power can be stored in the rechargeable battery unit. That is, the power condition unit is provided to regulate the electric power for supplying the load and charging the rechargeable battery unit when the photovoltaic panel can provide the electric power. At the same time, the charging control unit charges the rechargeable battery unit by controlling required charging voltage and charging current of the rechargeable battery unit. In addition, the charging control unit can also control operating points of the DC voltage and the DC current generated from the photovoltaic panel to provide a maximum power point tracing (MPPT) control.

Similarly, the switch control unit turns off the first switch unit and turns on the second switch unit when the photovoltaic panel cannot provide the electric power so that the electric power stored in the rechargeable battery unit is regulated to supply the load by the power condition unit in the step (S400). That is, the power condition unit is provided to regulate the electric power stored in the rechargeable battery unit for supplying the load when the photovoltaic panel cannot provide the electric power.

In conclusion, the present invention has following advantages:

1. The first switch unit and the second switch are controlled by the switch control unit according to daytime/evening or climatic conditions, thus achieving an adaptive power control of the photovoltaic powered system;

2. When the photovoltaic panel can provide the electric power, different power-supplying loops are provided to supply the load or to charge the rechargeable battery unit so that the photovoltaic panel can directly supply the load without operating the charging control unit, thus significantly increasing the whole efficiency of the photovoltaic powered system.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A photovoltaic powered system with an adaptive power control generating a DC voltage and a DC current through a photovoltaic panel, the DC voltage and the DC current controlled to provide an electric power to supply a load; the photovoltaic powered system comprising:
a charging control unit electrically connected to the photovoltaic panel;
a rechargeable battery unit electrically connected to the photovoltaic panel and the charging control unit;
a first switch unit electrically connected to the photovoltaic panel;
a second switch unit electrically connected to the charging control unit and the rechargeable battery unit;
a power condition unit electrically connected to the photovoltaic panel, the first switch unit, and the second switch unit; and
a switch control unit electrically connected to the photovoltaic panel, the first switch unit, and the second switch unit; the switch control unit receiving the DC voltage and the DC current generated from the photovoltaic panel to turn on/off the first switch unit and the second switch unit;
wherein the electric power generated from the photovoltaic panel is regulated to supply the load by the power condition unit and the electric power generated from the photovoltaic panel is controlled to charge the rechargeable battery unit by the charging control unit, the switch control unit turns on the first switch unit and turns off the second switch unit when the photovoltaic panel can provide the electric power;
wherein the electric power stored in the rechargeable battery unit is regulated to supply the load by the power condition unit, the switch control unit turns off the first switch unit and turns on the second switch unit when the photovoltaic panel cannot provide the electric power.

2. The photovoltaic powered system of claim 1, wherein the first switch unit is turned on and the second switch unit is turned off, the power condition unit controls an amount of the electric power generated from the photovoltaic panel and regulates an amount of the electric power provided to the load when the photovoltaic panel can provide the electric power.

3. The photovoltaic powered system of claim 2, wherein the power condition unit controls the amount of the electric power generated from the photovoltaic panel by controlling operating points of the DC voltage and the DC current.

4. The photovoltaic powered system of claim 3, wherein the power condition unit provides a maximum power point tracing (MPPT) control to control the DC voltage and the DC current operated under the maximum power point, thus generating the maximum electric power from the photovoltaic panel.

5. The photovoltaic powered system of claim 1, wherein the first switch unit is turned on and the second switch unit is turned off, the charging control unit charges the rechargeable battery unit by controlling required charging voltage and charging current of the rechargeable battery unit when the photovoltaic panel can provide the electric power.

6. The photovoltaic powered system of claim 1, wherein the first switch unit is turned off and the second switch unit is turned on, the power condition unit regulates the electric power stored in the rechargeable battery unit to supply the load when the photovoltaic panel cannot provide the electric power.

7. The photovoltaic powered system of claim 1, wherein the switch control unit produces a first control signal and a second control signal to turn on/off the first switch unit and the second switch unit, respectively.

8. The photovoltaic powered system of claim 7, wherein the first control signal and the second control signal are complementary-level signals; the second control signal is a low-level signal when the first control signal is a high-level signal and the second control signal is a high-level signal when the first control signal is a low-level signal.

9. The photovoltaic powered system of claim 1, wherein the power condition unit is a DC-to-AC inverter.

10. A method of operating a photovoltaic powered system with an adaptive power control, a photovoltaic panel generating a DC voltage and a DC current, the DC voltage and the DC current controlled to provide an electric power to supply a load; steps of operating the photovoltaic powered system with an adaptive power control comprising:
(a) providing a charging control unit and a rechargeable battery unit;
(b) providing a first switch unit and a second switch unit;
(c) providing a power condition unit; and
(d) providing a switch control unit;
wherein the switch control unit receives the DC voltage and the DC current generated from the photovoltaic panel to turn on/off the first switch unit and the second switch unit.

11. The method of operating the photovoltaic powered system of claim 10, in the step (d), wherein the electric power generated from the photovoltaic panel is regulated to supply the load by the power condition unit and the electric power generated from the photovoltaic panel is controlled to charge the rechargeable battery unit by the charging control unit, the switch control unit turns on the first switch unit and turns off the second switch unit when the photovoltaic panel can provide the electric power.

12. The method of operating the photovoltaic powered system of claim 11, wherein the first switch unit is turned on and the second switch unit is turned off, the power condition unit controls an amount of the electric power generated from the photovoltaic panel and regulates an amount of the electric power provided to the load when the photovoltaic panel can provide the electric power.

13. The method of operating the photovoltaic powered system of claim 12, wherein the power condition unit controls the amount of the electric power generated from the photovoltaic panel by controlling operating points of the DC voltage and the DC current.

14. The method of operating the photovoltaic powered system of claim 13, wherein the power condition unit provides a maximum power point tracing (MPPT) control to control the DC voltage and the DC current operated under the maximum power point, thus generating the maximum electric power from the photovoltaic panel.

15. The method of operating the photovoltaic powered system of claim 11, wherein the first switch unit is turned on and the second switch unit is turned off, the charging control unit charges the rechargeable battery unit by controlling required charging voltage and charging current of the rechargeable battery unit when the photovoltaic panel can provide the electric power.

16. The method of operating the photovoltaic powered system of claim 10, in the step (d), wherein the electric power outputted from the rechargeable battery unit is regulated to supply the load by the power condition unit, the switch control unit turns off the first switch unit and turns on the second switch unit when the photovoltaic panel cannot provide the electric power.

17. The method of operating the photovoltaic powered system of claim 16, wherein the first switch unit is turned off and the second switch unit is turned on, the power condition unit regulates the electric power stored in the rechargeable battery unit to supply the load when the photovoltaic panel cannot provide the electric power.

18. The method of operating the photovoltaic powered system of claim 10, in the step (d), wherein the switch control unit produces a first control signal and a second control signal to turn on/off the first switch unit and the second switch unit, respectively.

19. The method of operating the photovoltaic powered system of claim 18, wherein the first control signal and the second control signal are complementary-level signals; the second control signal is a low-level signal when the first control signal is a high-level signal and the second control signal is a high-level signal when the first control signal is a low-level signal.

20. The method of operating the photovoltaic powered system of claim 10, wherein the power condition unit is a DC-to-AC inverter.
